(19) United States
(12) Patent Application Publication
(10) Pub. No.: US 2015/0287980 A1
(43) Pub. Date: Oct. 8, 2015

(54) METHOD OF PRODUCING POROUS ELECTRODES FOR BATTERIES AND FUEL CELLS

(71) Applicants: Zhongwei CHEN, (US); Jordan Douglas SCOTT, Morriston (CA)

(72) Inventors: Zhongwei CHEN, Waterloo (CA); Jordan Douglas SCOTT, Morriston (CA)

(21) Appl. No.: 14/435,107

(22) PCT Filed: Oct. 11, 2013
(86) PCT No.: PCT/CA2013/050776

§ 371 Date: Apr. 10, 2015

Related U.S. Application Data
(60) Provisional application No. 61/795,211, filed on Oct. 12, 2012.

(51) Int. Cl. H01M 4/24; H01M 4/04

(52) U.S. Cl. CPC H01M 4/244; H01M 4/043; H01M 2004/021

(57) ABSTRACT

A method is provided for producing a porous electrode, in particular an anode, the method comprising forming a powder mixture comprising a metal powder and a filler material powder, pressing the powder mixture to form a compact, and heating the compact. The metal is preferably zing and/or a zinc alloy. The filler material is chosen from materials that are susceptible to being converted into a gaseous state upon application of heat.

### CROSS REFERENCE TO PRIOR APPLICATIONS

The present application claims priority under the Paris Convention to U.S. Application No. 61/795,211, filed Oct. 12, 2012, the entire contents of which are incorporated herein by reference.

### FIELD OF THE INVENTION

The present invention generally relates to metal-air batteries and fuel cells. In particular, the present invention is related to methods of making a porous electrode for use in metal-air batteries and fuel cells.

### BACKGROUND OF THE INVENTION

Electrochemical devices, such as metal-air batteries and metal-air fuel cells, are very promising energy conversion technologies that provide alternatives to the use of fossil fuels. As is known in the art, a typical metal-air battery or fuel cell comprises an anode, a cathode and a separator. The anode is generally formed using metals such as zinc (Zn), aluminum (Al) and/or lithium (Li). During the discharge of such batteries and fuel cells, oxidation of the metal occurs at the anode, which releases electrons. The electrons are transported via an external circuit to the cathode. At the cathode, an oxygen reduction reaction occurs, converting oxygen from air and water from an electrolyte into hydroxide ions. In zinc-air batteries in particular, hydroxide ions then migrate through the electrolyte and the separator to reach the anode where they form a metal salt (e.g. zincate), which decays into a metal oxide (e.g. zinc oxide). The reactions that occur at the anode and the cathode are well known, and are further described by Chakkaravarthy et al. (C. Chakkaravarthy et al. (1981); “Zinc-air alkaline batteries—A review”; Journal of Power Sources, 6(3): 203-228).

One way of enhancing the performance of batteries or fuel cells is to use porous electrodes, which have greater surface area-to-volume ratios in comparison, for example, to conventional non-porous, or “plate” electrodes. The greater surface area-to-volume ratios of porous electrodes are particularly advantageous, since they increase the amount of surface area for conducting the above mentioned reactions without increasing the overall size of the batteries or fuel cells. Various methods for forming porous electrodes, such as zinc anodes, have been proposed, some of which are described below. The known methods often involve multiple steps and/or have high energy demands, thereby making them economically or functionally inefficient. In addition, a number of the known methods require environmentally toxic or damaging reagents.

U.S. Pat. No. 5,599,637 to Pecherer et al. describes a porous anode formed by a method wherein a slurry of zinc granules suspended in solution is compacted under pressure to bind the zinc granules onto a conductive skeletal frame. However, the method described by Pecherer et al. requires a skeletal frame having holes formed therein for binding the zinc granules.

US Publication No. 2009/0183996 to Richter et al. describes a process for forming a porous anode comprising anodic oxidation of a metal and subsequent reaction with an organic compound to form a porous metal organic framework.

U.S. Pat. No. 7,179,310 to Jiang et al. describes a method for producing an anode, comprising forming a wet mixture by mixing zinc particles, a gelling agent and water, molding the wet mixture in a mold cavity, and drying the molded wet mixture to obtain a porous zinc mass.

A fibrous anode is also known in the art, which can be produced by spinning molten zinc into fibers and then compressing the fibers to shape the anode. For example, a fibrous anode and a method for producing the same are provided in US Publication No. 2006/0093909 to Zhang. Similarly, US Publication No. 2010/0143826 to Schechner et al. describes a fibrous mat anode produced by electro-spinning zinc into fibers and then compressing the fibers. However, the anodes produced using these methods are generally not very durable, and are therefore not suitable for long-term use or in applications requiring high reliability. Additionally, these methods are generally energy intensive and the resulting pores, or voids, formed in the anodes typically have elongate shapes.

There exists a need for a method for producing a porous electrode, in particular a zinc or zing alloy anode that alleviates at least one of the deficiencies known in the art.

### SUMMARY OF THE INVENTION

In a broad aspect, the present invention provides a method for producing a porous electrode, such as an anode. The method comprises forming the electrode from a powder mixture comprising metal particles and filler material particles. The pores of the electrode are formed by converting the filler material particles into gaseous form.

Thus, in one aspect, the invention provides a method for producing a porous electrode, the method comprising:
forming a powder mixture comprising: a first powder comprising metal particles; and, a second powder comprising filler material particles, wherein the filler material is susceptible to being converted into a gaseous form upon application of heat;
pressing the powder mixture to form a compact; and,
heating the compact to convert the filler material to its gaseous form and to anneal the metal particles.

### BRIEF DESCRIPTION OF THE DRAWINGS

The features of the invention will become more apparent in the following detailed description in which reference is made to the appended drawings wherein:

FIGS. 1A to 1C schematically illustrate the method according to one embodiment.

FIG. 2A is a photograph of a compact formed in one example.

FIG. 2B is a micrograph of the surface of the compact shown in FIG. 2A taken using an optical microscope at a magnification of 60×.

FIG. 3A is a photograph of a porous electrode produced according to an embodiment of the invention.

FIG. 3B is a micrograph of the surface of the porous electrode shown in FIG. 3A taken using an optical microscope at a magnification of 60×.

FIG. 4 is a plot of potential vs. current showing the charge and discharge characteristics of fuel cells comprising a conventional plate anode and a porous anode formed according to an embodiment of the invention.

FIG. 5 is an EDX spectrum of a conventional zinc plate electrode obtained using an energy dispersive x-ray spectrometer (EDX).

FIG. 6 is an EDX spectrum of a porous electrode formed according to an embodiment of the invention.

### DETAILED DESCRIPTION OF THE INVENTION

The terms “comprise”, “comprises”, “comprised” or “comprising” may be used in the present specification. As used herein, these terms are to be interpreted as specifying the presence of the stated features, integers, steps or components, but not as precluding the presence of one or more other feature, integer, step, component or a group thereof as would be apparent to persons having ordinary skill in the relevant art.

In one aspect, the invention provides a method for producing a porous electrode, in particular an anode, the method comprising mixing a metal powder, comprising metal particles or grains, with a powdered filler material, also comprising particles or grains, to create a powder mixture. The filler material is one that is convertible into a gas upon heating. The powder mixture is then compacted and heated (i) to convert the filler particles into gaseous form and (ii) to anneal the metal particles together. As the filler particles are converted to a gas, the volumes previously occupied by the filler particles are thus converted into pores within the metal matrix. As will be understood, in order to obtain a uniform distribution of pores in the resulting electrode of the invention, the filler particles would preferably be uniform in size and uniformly mixed with the metal particles.

The metal used in the present invention preferably comprises zinc and/or a zinc alloy. The filler material is preferably one that undergoes sublimation or decomposition when subjected to heat. Preferably, the sublimation or decomposition temperature of the filler material is at or near the annealing temperature of the metal particles, thereby minimizing the amount of energy required to form the electrode. In the case of zinc and/or a zinc alloy powder, the annealing temperature would be approximately 300° C. or higher. In one aspect, the powder mixture comprises zinc and/or zinc alloy particles, and the compact is heated to approximately 350° C.

In addition to the metal and filler particles, one or more other materials may optionally be added to the powder mixture in order to impart any desired properties to the electrode. For example, in one embodiment, conductive materials such as carbon nanofibers and/or carbon nanotubes may be incorporated into the powder mixture to improve the performance and/or stability of the electrode.

The metal powder used in the method of the invention may be formed according to any known method, such as for example, by atomization. It will be appreciated that the invention is not limited to any specific process for producing the metal powder. In one embodiment, the metal powder consists entirely or partially of zinc and/or a zinc alloy powder. It will be appreciated that various zinc alloy materials will be known to persons skilled in the art for use as an anodic material. It will also be understood that the present invention is not limited by the choice of metal.

According to one embodiment, the filler material may comprise aluminum chloride (AlCl₃) and/or ammonium chloride (NH₄Cl). As indicated above, the filler is preferably in a powder form when creating the mixture with the metal powder and is generally one that is convertible to a gas at a temperature at or near the annealing temperature of the metal.

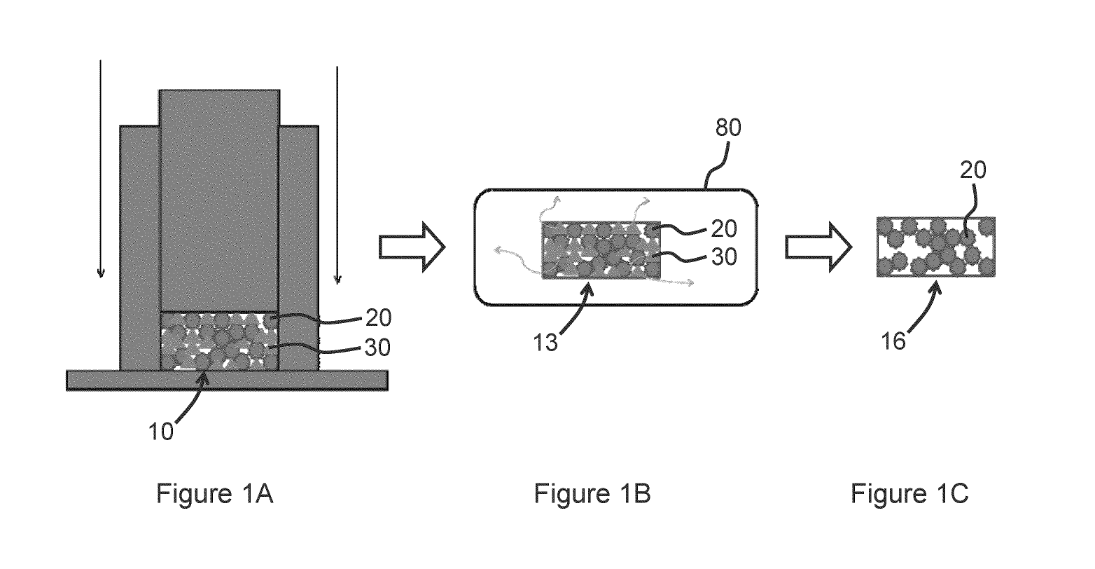

A method according to one embodiment of the invention is illustrated in FIGS. 1A to 1C. As shown in FIG. 1A, a powder mixture 10 comprising the desired metal particles 20 and dispersed filler particles 30 is formed. The powder mixture 10 is then pressed to form a compact 13. As shown in FIG. 1B, the compact 13 is then heated to convert the filler 30 into a gas and to anneal the metal particles 20 together. The compact 13 may be heated, for example, by placing the compact 13 in a furnace 80. Once cooled, the resulting porous electrode 16 is formed, as illustrated in FIG. 1C.

In one embodiment, the filler 30 comprises a material that is convertible into a gaseous state through sublimation. As is well known in the art, sublimation is a direct phase transition of a substance from the solid phase to the gas phase. Sublimation generally occurs when a substance is heated while being subjected to pressures below the triple point of the substance. As such, it will be understood that the temperature and the pressure that the compact 13 is subjected to during heating will vary depending on the characteristics of the filler 30. Thus, in one embodiment, the filler 30 may comprise aluminum chloride (AlCl₃), which sublimates at approximately 180° C.

In another embodiment, the filler 30 comprises a material that is convertible to one or more gases through thermal decomposition. For example, the filler 30 may comprise ammonium chloride (NH₄Cl), which decomposes into ammonia and hydrogen chloride gas when heated to approximately 338° C. under atmospheric pressure.

Preferably, the compact 13 is heated in an inert gas environment, such as argon or nitrogen. As will be understood, such an environment reduces the likelihood of the metal material from becoming oxidized during heating or otherwise undergoing any other reaction with air or other gases.

As discussed above, the method of the invention may be conducted with one heating step, wherein the conversion of the filler material is achieved at the same time as annealing of the metal component(s). However, in another embodiment of the invention, the method may involve two heating steps, namely, a first heating step, wherein the compact 13 is heated to a conversion temperature for converting the filler particles 30 to a gas, and second heating step, wherein the compact 13 is then further heated to an annealing temperature for annealing the metal particles 20.

As discussed above, the conversion of the filler particles to a gas results in the formation of pores or voids in sites previously occupied by the filler particles 30. As illustrated in FIG. 1B, the converted gas is released from the compact 13 during the conversion step. In one embodiment, the converted gas may be recovered and later reused. It will be appreciated that, during heating, the compact 13 may be maintained at or above the conversion temperature for a period of time to allow sufficient conversion.

It will be appreciated that the physical characteristics of the porous electrode 16, including its porosity, surface area and the overall structure, may vary depending on a variety of process parameters. For example, the porosity of the electrode may depend on the particle sizes of the metal and filler material. As will be understood, the particle size of the filler material will determine the size of the pores formed in the electrode. Similarly, the relative amounts of the metal and filler particles will also determine the resulting porosity. For example, the porosity of the electrode may be determined by increasing or reducing the relative amount of the filler particles compared to the metal particles.

Another variable that may affect the resulting electrode porosity is the degree to which the filler material is converted to its gaseous state. For example, the resulting porosity may be limited by limiting the heating time of the compact.

In one embodiment, the powder mixture may be pressed against a support or scaffold to provide the resulting electrode with a particular shape or structure. For example, in one aspect, the powder mixture may be pressed or formed against a scaffold or support comprising foam, a mesh, rods, fibers, nanotubes, a sheet, or a perforated sheet, or any combination thereof. In one embodiment, the support may comprise a current collector formed of an electrically conductive material such as, but not limited to, copper, aluminum, carbon, and/or nickel.

The porous electrode produced according to the method described herein may be used in batteries, fuel cells and the like. In a preferred embodiment, the electrode comprises an anode for use in a metal-air battery or fuel cell. In such case, the electrode comprises an anode formed using zinc and/or zinc alloy powder.

The porous electrode formed according to the above method may be further treated to aid its implementation in a battery or fuel cell. For example, in one aspect, the electrode may be coated with one or more polymers, surfactants etc. As will be understood by persons skilled in the art, such coatings could be used to prevent formation of dendrites, facilitate the operation of the electrode in a solid electrolyte cell or otherwise enhance the performance or durability of the electrode.

Aspects of the invention will now be illustrated with reference to the following examples, which are not intended to limit the scope of the invention in any way.

### Example 1

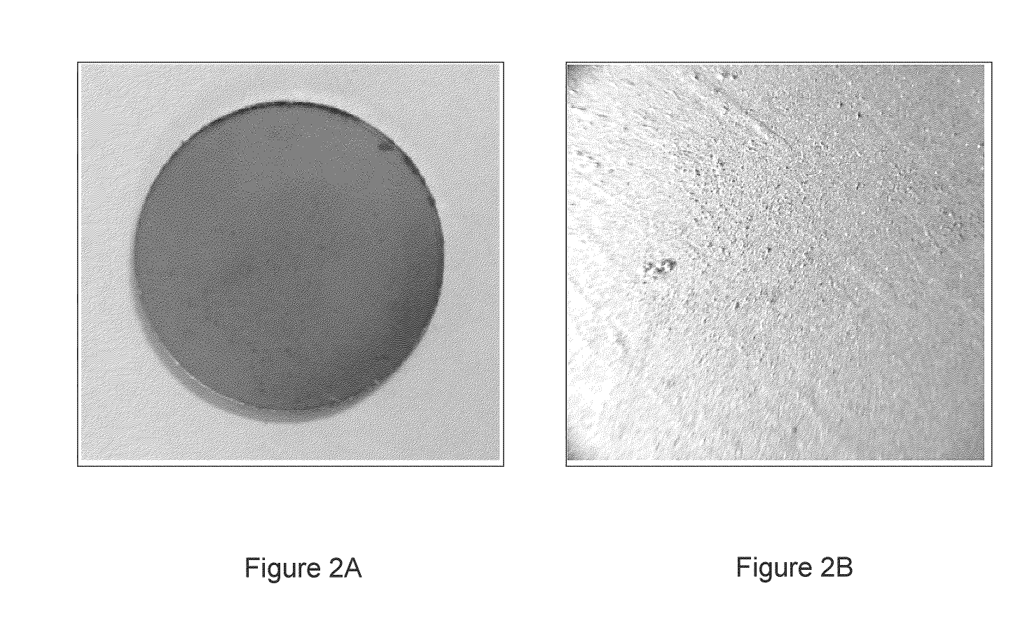

A porous anode was produced using a base material of atomized zinc powder. The filler compound selected for use was ammonium chloride. No support was used and the anode was free standing. The base material and the filler were mixed and pressed into a disc using a hydraulic press, to a pressure at which the anode remained a single unbroken piece as seen in FIGS. 2A and 2B.

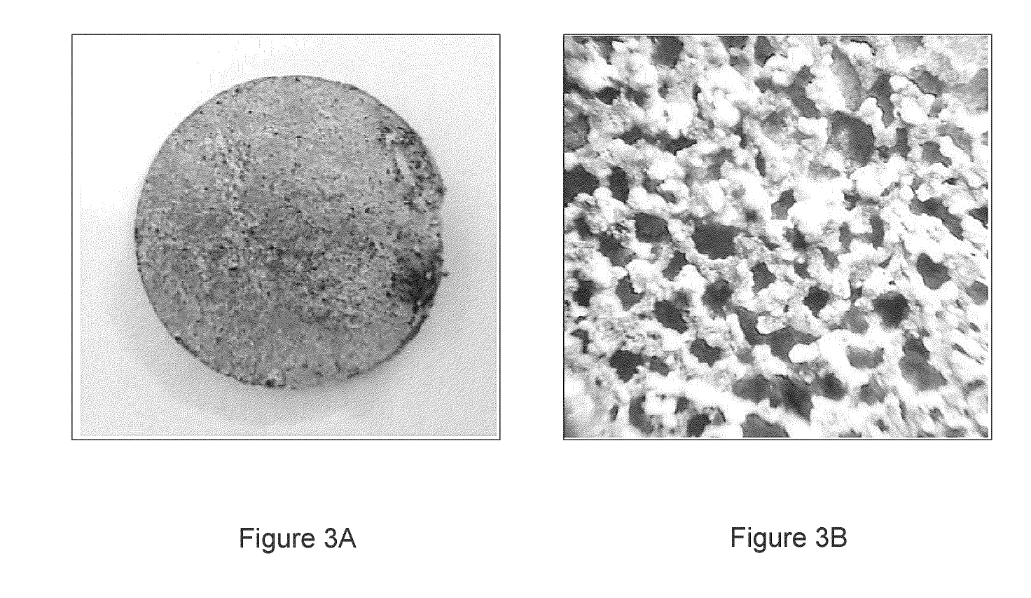

The compact was then placed in a tube furnace inside a quartz tube and heated to 350° C. at a ramp rate of 10° C./min under an argon environment in order to avoid unnecessary oxidation of the zinc. The sample was similarly cooled at a rate of 10° C./min under argon, and then removed from the furnace and washed with water to remove zinc chloride that might have formed due to reaction with HCl released by the ammonium chloride. The sample was further dried in air at 60° C. for 2 hours. A photograph and micrograph of the sample after the heat treatment is shown in FIGS. 3A and 3B, respectively.

In comparing FIG. 2A, 2B and FIGS. 3A, 3B, it can be clearly seen that the anode becomes significantly more porous after the heat treatment process, indicating that the process is successful in creating porous anodes.

### Example 2

The performance of the anode formed Example 1 was analyzed under full cell testing, using an acrylic cell. For comparison, the performance test was separately conducted using a conventional plate anode. The cathode used was lanthanum nickel oxide coated onto a gas diffusion layer of carbon. The electrolyte used was 6M KOH. The current was varied from 0 to 300mA during the cycling for both discharge and charge stages.

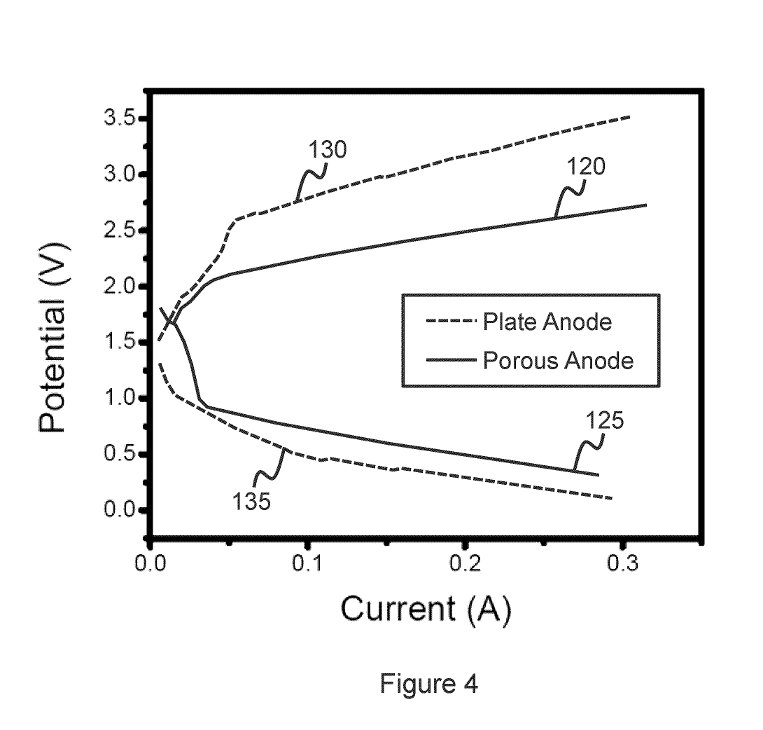

The cell cycling test results for both the conventional anode and the anode of Example 1 are shown in FIG. 4. In the present example, the charge potential and the discharge potential of devices incorporating the anodes were measured at various currents. In FIG. 4, the charge and discharge curves of the device incorporating the porous anode are labelled 120 and 125, respectively. The charge and discharge curves of the device incorporating the conventional plate anode are labelled 130 and 135, respectively. The charge potential and the discharge potential of cells incorporating the two anodes, at current levels of 100 mA, 200 mA and 300 mA, are summarized in Table 1 below.

TABLE 1
Comparison of charge and discharge performances

| | | Current (mA) | | |
|---|---|---|---|---|
| | | 100 | 200 | 300 |
| Discharge | Plate Anode | 0.582 | 0.332 | 0.106 |
| potential (V) | Porous Anode | 0.700 | 0.475 | 0.306 |
| Charge | Plate Anode | 2.757 | 3.155 | 3.495 |
| potential (V) | Porous Anode | 2.246 | 2.466 | 2.673 |

As can be seen, there is a significant improvement in performance noted for the porous anode developed according to the present invention, wherein there is a reduction in the recharge potential of the cell by over 0.8V at 300 mA of current. The porous anode also demonstrated an increase in discharge voltage by 0.2V at 300 mA. Both of these changes in the recharge potential and discharge potential are highly beneficial to cell performance.

### Example 3

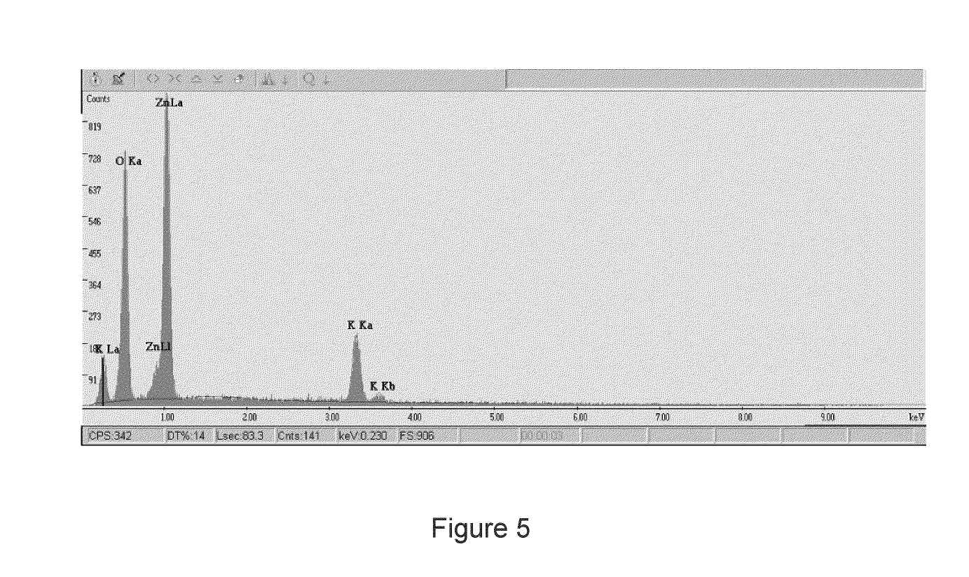

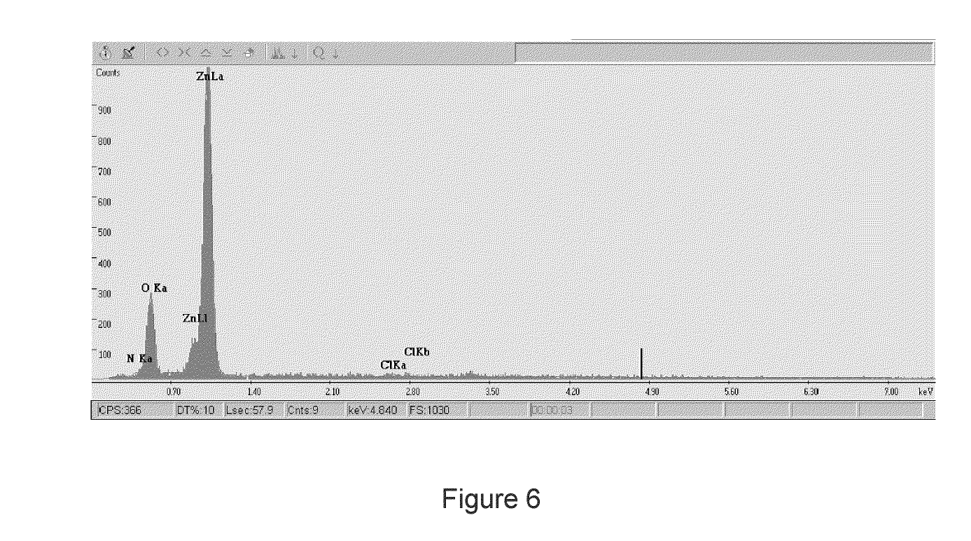

The anode of Example 1 was characterized using energy dispersive x-ray spectroscopy (EDX) to confirm the amount of filler material that was removed in the heating step. This analysis was conducted using the anode of Example 1 and a conventional plate anode for the purposes of comparison. The results of the EDX analysis is summarized below in Table 2 and illustrated in FIGS. 5 and 6.

TABLE 2
Comparison of EDX results

| Element | Plate Anode (wt %) | Porous Anode (wt %) |
|---|---|---|
| O | 28.36 | 14.06 |
| Zn | 51.97 | 83.64 |
| K | 19.67 | — |
| Cl | — | 0.93 |
| N | — | 1.36 |

The porous anode analyzed here was created using ammonium chloride as a filler compound. It can be clearly seen that very little of the filler compound remained in the sample, indicating that the heat treatment used was sufficient in removing the filler.

Although the invention has been described with reference to certain specific embodiments, various modifications thereof will be apparent to those skilled in the art. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

1. A method for producing a porous electrode, the method comprising:
forming a powder mixture comprising: a first powder comprising metal particles;
and, a second powder comprising filler material particles, wherein the filler material is susceptible to being converted into a gaseous form upon application of heat;
pressing the powder mixture to form a compact; and,
heating the compact to convert the filler material to its gaseous form and to anneal the metal particles.

2. The method according to claim 1, wherein the filler material is convertible to a gaseous form by sublimation.

3. The method according to claim 2, wherein the filler material comprises aluminum chloride particles.

4. The method according to claim 1, wherein the filler material is convertible to a gaseous for by thermal decomposition.

5. The method according to claim 4, wherein the filler comprises ammonium chloride particles.

6. The method according to claim 1, wherein the first powder comprises a zinc powder and/or a zinc alloy powder.

7. The method according to claim 1, wherein the powder mixture further comprises carbon nanofibers and/or carbon nanotubes.

8. The method according to claim 1, wherein the powder mixture is pressed against a support or scaffold.

9. The method according to claim 8, wherein the support is foam, a mesh, rods, fibers, nanotubes, a planar sheet, or a perforated sheet or any combination thereof.

10. The method according to claim 8, wherein the support is formed of an electrically conductive material.

11. The method according to claim 10, wherein the support is formed of copper, aluminum, carbon, nickel, or any combination thereof.

12. The method according to claim 1, wherein the step of heating the compact further comprises:
heating the compact to a first temperature for converting the filler material to its gaseous form; and,
further heating the compact to a second temperature for annealing the base material.

13. The method according to claim 1, wherein the electrode is an anode.

14. A porous electrode produced according to the method according claim 1.
